(19) United States
(12) Patent Application Publication
(10) Pub. No.: US 2023/0060626 A1
(43) Pub. Date: Mar. 2, 2023

(54) LOCK SYSTEM, APPARATUS, AND METHOD FOR CONTROLLING ACCESS TO A TOILET

(71) Applicant: Maximizing Joy Enterprises, LLC, Atlanta, GA (US)

(72) Inventors: Julie Kathleen Stevens, Atlanta, GA (US); Armando Pastrana, Ft. Worth, TX (US); David Rice Doan, Tucker, GA (US)

(21) Appl. No.: 17/899,542

(22) Filed: Aug. 30, 2022

Related U.S. Application Data
(60) Provisional application No. 63/238,711, filed on Aug. 30, 2021.

(51) Int. Cl. G07C 9/28; G07C 9/00

(52) U.S. Cl. CPC G07C 9/28; G07C 9/00174; G07C 2009/00769

(57) ABSTRACT

A system, apparatus, and method for toilet reservation and access are disclosed. One embodiment of the system comprises: an enclosure defining an enclosable space containing a toilet, the enclosure having an entry to the enclosable space; a lock having an open position and a locked position, the lock cyclable between the locked position and the open position for controlling use of the entry to access the enclosable space via the entry; and a lock controller, the lock controller operable to cause said lock to cycle between the locked position and open position, wherein said controller is configured to cause said lock to cycle during a scheduled time based on receiving a user-provided access code that is a valid access code for the scheduled time.

### RELATED APPLICATIONS

This application claims the benefit of priority under 35 U.S.C. 119(e) to U.S. Provisional Pat. Application No. 63/238,711, entitled “System, Apparatus, and Method for Toilet Reservation and Security,” filed Aug. 30, 2021, which is hereby fully incorporated herein by reference.

### TECHNICAL FIELD

The present disclosure relates generally to toilets available for general use. In particular, the present disclosure relates to a system, apparatus, and method for a toilet available for public use. Even more particularly, the present disclosure relates a system, apparatus, and method for a public use and/or portable toilet that supports reservations via a wireless network or other electronic mechanism. Embodiments further relate to toilet security.

### BACKGROUND

Available public toilets, and in particular, temporary or portable toilets (commonly known as porta-potties or porta-loos), do not offer users a pleasant toilet experience. Often these types of toilets are the only toilet facilities available at high-density events such as concerts, outdoor festivals, and other similar events, where it is already not only difficult to find the available toilet facilities, but they are also typically overcrowded, unclean, and in a generally unpleasant condition. Furthermore, users at such events are typically hot, tired, dirty, and looking for a bit of refuge in their toilet experience.

Currently available toilet facilities for public use therefore do not usually provide a desirable user experience, instead being unpleasant and unsanitary (bad smell, dirty, minimally maintained). Furthermore, these types of moveable, typically free-standing toilets do not provide security beyond a rudimentary manually operated lock that can easily be bypassed. When available, the typical locking device must be manually operated from within the toilet and will not prevent access to the toilet when the toilet is not in use. This presents a problem in that if the owner/operator of the toilet desires to restrict access to the public, for example if the toilet is out of service, or to limit access only to selected users, the operator is unable to do so. In particular, an operator cannot do so automatically, remotely, or in a predefined manner by providing a key (physical or electronic) to access the toilet. Instead, potential users of available toilets today can access any such toilet in an uncontrolled manner, subject only to waiting in a queue if one exists.

Typically, users of existing public toilets do have to wait in queues, which may be lengthy at certain types of events. Users today have no way to reserve publicly available toilets in advance or on the go either for exclusive use, say over a set period of time, or for a single scheduled use. Further, finding a toilet that is not in use is mainly by trial and error, or waiting in a queue in hopes that once the user obtains access to the toilet, the toilet will be in a clean and usable condition. Often, this is not the case today. A user cannot easily determine the location of an available toilet (or schedule a time for the toilet to be free), nor have a guarantee that the toilet will be clean, stocked, and in good condition for use.

Still further, easily accessible and reliable portable toilets are not typically available at large scale public events that are welcoming for certain populations, such as breastfeeding mothers, potty-training toddlers, people with auto-immune disorders, etc. Other types of portable toilets beyond a typical stand-alone single person portable toilet, such as larger multi-toilet trailers which might be more easily accessible to these populations, can be much more expensive to operate, and hence cost prohibitive, for these types of events and do not reduce the number of germs that could be present in a typical public use restroom. These issues then, effectively reduce accessibility to certain people as these populations are thus not as likely to attend events where portable toilets are the primary toilet option.

Therefore, a need exists for a toilet system, apparatus, and method that can be automatically maintained, reserved in advance or on the go, and securely accessed over a set period over a network or via local electronic means while overcoming some or all of the problems and disadvantages associated with existing publicly available toilets.

### SUMMARY

The embodiments described herein provide systems, apparatuses, methods, and computer program products for reserving, accessing, and monitoring toilets.

One embodiment of a toilet reservation and access system comprises: an enclosure defining an enclosable space containing a toilet, the enclosure having an entry to the enclosable space; a lock having an open position and a locked position, the lock cyclable between the locked position and the open position for controlling use of the entry to access the enclosable space via the entry; and a lock controller, the lock controller operable to cause said lock to cycle between the locked position and open position, wherein said controller is configured to cause said lock to cycle during a scheduled time based on receiving a user-provided access code that is a valid access code for the scheduled time.

According to one aspect of the present disclosure the lock controller comprises a memory storing a plurality of access codes.

According to another aspect of the present disclosure, the lock controller is configured to: receive, from a server, a schedule for a first access code from the plurality of access codes; and determine that the user-provided access code is valid for the scheduled time based on the user-provided access code matching the first access code and a current time being a valid time according to the schedule.

According to yet another aspect of the present disclosure, the memory stores a schedule for a first access code from the plurality of access codes, and wherein the lock controller is configured to: determine that the user-provided access code is the valid access code for the scheduled time based on the user-provided access code matching the first access code and a current time being a valid time according to the schedule.

According to another aspect of the present disclosure, the lock controller is configured to send the user-provided access code to a server for validation.

According to another aspect of the present disclosure, the system comprises a code reader operatively connected to the lock controller. The lock controller is configured to receive the user-provided access code from the code reader. By way of example, but not limitation the code reader is a QR code reader, an RFID reader, or an NFC reader.

According to yet another aspect of the present disclosure, the lock comprises a locking mechanism; and an actuator to actuate the locking mechanism, wherein the lock controller is configured to control the actuator to cycle the locking mechanism between the open position and the locked position.

According to yet another aspect of the present disclosure, the toilet reservation and access system further comprises a server. The server comprises a processor and a non-transitory computer readable medium storing thereon computer-executable instructions. The computer-executable instructions comprise instructions for providing a catalog of available toilet options to a client device; receiving from the client device a request to reserve the toilet for a requested date and time; assigning an access code to a user to allow the user to access the toilet at the requested date and time; sending the access code to the user; and updating the catalog of available toilet options to remove the requested date and time for the toilet from the catalog of available toilet options.

Another embodiment includes a toilet reservation and access method that comprises locking an entry to an enclosure defining an enclosable space containing a toilet with an electronically actuated lock that is cyclable between a locked position and an open position for controlling use of the entry to access the enclosable space via the entry; receiving (e.g., wirelessly) a user-provided access code to access the toilet; and actuating the electronically actuated lock to cycle the electronically actuated lock between the locked position and the open position during a scheduled time to allow access to the enclosable space based on a determination that the user-provided access code is a valid access code for the scheduled time.

According to one aspect of the present disclosure, the toilet reservation and access method includes storing a plurality of access codes in a controller memory of a lock controller that is communicatively coupled to the electronically actuated lock and associating a schedule with a first access code from the plurality of access codes.

According to another aspect of the present disclosure, the toilet reservation and access method includes configuring the lock controller with the schedule for the first access code via a wireless command.

According to another aspect of the present disclosure, the lock controller receives the schedule from a server.

According to another aspect of the present disclosure, the toilet reservation and access method includes, determining that the user-provided access code is valid for the scheduled time based on the user-provided access code matching the first access code and a current time being a valid time according to the schedule.

According to another aspect of the present disclosure, the toilet reservation and access method includes reading the user-provided access code using a code reader coupled to the enclosure and sending the user-provided access code to a server for validation.

According to another aspect of the present disclosure includes providing a catalog of available toilet options; receiving a request to reserve the toilet for a requested date and time; assigning a first access code to a user to allow the user to access the toilet at the requested date and time; sending the first access code to the user; and updating the catalog of available toilet options to remove the requested date and time for the toilet from the catalog of available toilet options.

Another embodiment includes a computer program product comprising a non-transitory, computer-readable medium storing a set of computer-executable instructions. The set of computer executable instructions comprising instructions for: controlling an electronically actuated lock that is cyclable between an open position and a locked position to lock an entry to an enclosure housing a toilet; receiving (e.g., wirelessly) a user-provided access code to access the toilet; and actuating the electronically actuated lock to cycle the electronically actuated lock between the locked position and the open position during a scheduled time to allow access to the toilet based on a determination that the user-provided access code is a valid access code for the scheduled time.

According to one aspect of the present disclosure, the set of computer-executable instructions further comprises instructions for accessing a first access code and a schedule for the first access code from a memory; and determining that the user-provided access code is the valid access code for the scheduled time based on the user-provided access code matching the first access code and a current time being a valid time according to the schedule.

According to another aspect of the present disclosure, the set of computer-executable instructions comprises instruction for receiving the schedule for the first access code over a network from a server.

According to another aspect of the present disclosure, the set of computer-executable instructions further comprises instructions for sending the user-provided access code to a server for validation.

Other uses for a system, apparatus, and method for reserving and accessing a toilet designed in accordance with the teachings of this disclosure will be known to those having skill in the art.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1A is a diagrammatic representation of one embodiment of a system for reserving and accessing a toilet;

FIG. 1B is a diagrammatic representation of one embodiment of a connected lock;

FIG. 2 is a logic flow diagram illustrating one embodiment of a method for reserving a toilet;

FIG. 3 illustrates an embodiment of a method to reserve a toilet in advance of an event;

FIG. 4 illustrates an embodiment of a method for reserving access to a toilet in a 'real-time" situation while, for example, at an event;

FIG. 5 illustrates another embodiment of a method for reserving access to a toilet in a “real-time” situation, where a user purchases access to a group of toilets at an event; and

FIG. 6 illustrates another embodiment of a method to reserve a toilet, or access a group of toilets, in advance of an event.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

Various embodiments described herein provide for schedulable controlled access, either ad hoc or premeditated, for example in advance of a scheduled event, to a toilet enclosure. Access can be controlled via an electronically actuated lock capable of detecting and recognizing, for example, a secure QR code, Bluetooth signal, RFID signal, WIFI signal, Near Field ID (NFID) signal, cellular signal, or other such electronic or optical signal as may be known or developed in the art, including in some embodiments motion (e.g., a preset pattern of movement by a human or device), or a combination of these types of signals. Such a signal can be a signal generated by the lock itself and transmitted to detect and read data from another device or physical object (e.g., to read a printed symbol like a QR code, or read an RFID identifier from an RFID device). Embodiments can configure such an electronically actuated lock, via wired or wireless connection, to move to an unlocked position (allow access) upon detection of a signal, such as described above, where the lock is configured to recognize a particular access code in such signal. The access code can be provided by a user to the lock via a dedicated device (such as a physical tag encoded with the access code or a printout with an access code that can be optically detected and recognized) or via a device (such as a mobile phone) capable of displaying or transmitting an access code in a format the lock can recognize.

Embodiments can further comprise a connection to a network, such as the internet and/or a local area network, for receiving and sending data to and from the lock. The connection to the network can be a wired connection or a wireless connection provided via a transceiver, for example, a wireless modem or network router, or via a handheld device, including a handheld device provided by a user reserving a toilet of the embodiments. The transceiver can be integrated into the lock or be a separate device. Embodiments can comprise additional connected devices such as a light, a fan, a tank level sensor, disinfection devices (such as a UV Light, disinfectant sprayer, fogger, or fumigator), motion detectors, video, or sound detection devices such as a video camera, and power supply devices such as batteries, solar cells, or a connection to an external grid or power supply. The power supply devices can be connected devices that can be monitored or controlled via signals over the network. Connected devices such as described above can be operable to be controlled and/or monitored over the network in a manner as known in the art.

Embodiments can comprise a reservation application implemented via software on a computer device, either mobile, such as a smartphone or tablet, on a computer device intended to be at a fixed location, such as a personal computer, and/or hosted on the ‘cloud’ via a remote server and accessed via a mobile device or fixed location device. In some embodiments, the application is accessed via a website. The application is operable to allow a user to, for example, access a server to locate relevant toilets, determine their availability at a particular time, choose among a set of relevant toilets, and reserve a toilet to be accessed at a scheduled time. The server can be connected via a network, such as the internet, a LAN, or WAN, to a user’s device, and also to the toilet to be reserved. Once a user selects a toilet and reserves the toilet, the server can provide the user an access code via the application and/or by email, text, or other electronic means.

The application can also be operable to allow a user to receive the access code and provide the access code to the reserved toilet, for example once the user is near the toilet, to allow access at the scheduled time or event under a set of conditions selected by the user when reserving the toilet and provided by the server to the toilet over the network or via the application itself. The server can also be operable to provide an access code or other electronic key to the user configured to open the lock and configure the toilet based on a set of pre-existing conditions on the lock (i.e., without the need for the server to send any data to the lock over the network). The application can be operable to allow the user to control, in addition to the lock, other connected devices, such as turning a fan or light on and off, activating disinfection devices for disinfecting the restroom, operating a lifting device to lift (open) or lower (close) a toilet lid on a toilet, or viewing the feed from external cameras on the toilet enclosure prior to exiting the toilet enclosure to determine if any person or other potential threat is outside of the toilet. Handsfree operation of the connected devices is desirable for sanitary as well as convenience reasons. Viewing of camera feeds through the application could be desirable if the toilets are in a remote location or if the user is exiting the toilet enclosure in darkness

Embodiments of a reservation application can be implemented using any suitable programming language or operating system, such as Android, UNIX, Linux, iOS, etc. The application can be operable to allow a user to provide feedback relating to the toilet and its condition, the user’s perceptions, and indication of when the user has opened and locked the toilet lock. The lock can be operable to send a signal back to the server indicating when it is opened and locked. The indication provided by the cycling of the lock, among other indicators such as a tank level sensor, feedback from users, and/or motion detection, can be used to track and predict usage of a toilet and hence when the toilet may require restocking, cleaning, and maintenance.

The embodiments can comprise a computer implemented system for presenting available toilets, potentially differentiated by different levels of amenities (e.g., location, quality of materials, size, theme, etc.), and priced accordingly, to a user. Such a system can be hosted on a server and accessed by a user over a network, such as the internet, a LAN, or a WAN, either wirelessly, wired, or some combination thereof. The computer implemented portion of the embodiments can comprise a website or the application described above for providing a user an interface for selecting and reserving a toilet in accordance with the teachings herein.

The embodiments can be configured to cause operation of connected devices by the lock cycling or by a motion sensor detecting a person in the toilet enclosure (enclosable area). For example, upon a user presenting an access code that is accepted by the lock, the lock can cause, through wired or wireless connection to the connected devices, for all or some combination of connected devices to turn on or off. Likewise, the embodiments could cause such operation of the connected devices once a code is presented and accepted by a motion sensor detecting motion of a person entering the enclosure. For example, the lock or motion sensor could cause a fan and a light to turn on upon entry and off upon exit by a user. Motion detection of a user exiting the enclosure (or lack of detected motion after a predetermined interval of time) or opening and closing of the entry to the enclosure (in such embodiment comprising a sensor to detect opening and closing of the entry (e.g., a door), can cause the locking of the lock, and turning off of the fan and lights or operation of other connected devices in the embodiments such as the disinfecting devices when a user is not present in the toilet enclosure. The lock can also be configured to be operable to send a signal to the computer implemented system of the embodiments to indicate a use of the toilet has been completed (as can an increase in the level detected by a level sensor) that can then be used by such a system to predict servicing and maintenance of the toilet and can trigger the system to place the toilet back into the inventory of available toilets that can be reserved by a user. Embodiments can comprise a method to use data provided to the reservation system by a user, or by sensors and connected devices in a toilet, to predict when a toilet needs cleaning and maintenance. For example, feedback from users or number of uses of a toilet determined from cycling of the lock or other feedback, can be used to determine and trigger cleaning and maintenance when a set of predetermined parameters are met. Further, compiling and analyzing such data over time can be used to predict when cleaning and maintenance are required, in a manner as may be known in the art of data analytics.

The reservation system can be operable to allow a user to reserve an individual toilet for a set period of time, allow a user to reserve access to a group of toilets for a set period of time (i.e., the user can unlock and access any available toilet of such a group of toilets), or allow a user to purchase a subscription allowing access to an individual toilet or group of toilets over a longer set period of time (e.g., a weekly, monthly, or yearly subscription of a larger group of toilets). The user can select to reserve a toilet or group of toilets differentiated by amenities as previously described. A subscription may be desirable, for example, for a larger network of toilets over a larger geographic area such as a park service or an urban area where public toilets may not be readily available or may be available but undesirable for reasons of location, cleanliness, etc. The reservation system can also be operable to allow a user to select and purchase access to a toilet on an ad hoc basis, such as by using the application to locate available toilets nearby when nature calls, and then selecting and purchasing access to an available toilet for a single use of the access code. The user would be provided an access code as previously described in such an ad hoc situation.

The reservation system can be operable to allow a user to reserve a toilet as described herein as part of a third-party reservation. For example, a user can purchase tickets to an event (e.g., from an online ticketing organization) and be presented the option to purchase a toilet reservation for the event. If the configuration of available toilets for the event is known at the time of reservation, the user is presented with a list of available toilets that can be reserved. If the configuration is not yet known, the user can instead purchase a right to reserve once the configuration is known or can purchase access and allow the system to assign a toilet or group of toilets once the configuration is known. In either case, the user can be provided an access code at the time of purchase or sent an access code or a device (such as an event bracelet) having an access code at a later date prior to or at the event.

An access code or codes provided to a user by the embodiments of the system can be generated and/or stored in a database on a system server in such a way that the codes in the database match codes on a lock or other connected device of a reserved toilet. Once a user reserves a toilet and the system provides the user an access code, that code can be matched to an appropriately configured toilet, or the code itself when used on a toilet can be operable to configure the toilet to user-selected specifications. For example, a lock on a toilet (or a lock and a central system database) can be configured with a preset set of codes that the system can select from and assign to a user when the user reserves a toilet. When a user reserves a toilet (either a pre-configured toilet or a user-configured toilet), the system can assign a code to the user that will operate the lock and other devices on the selected toilet. The system can include as part of the code instructions that will cause the lock and other connected devices in a toilet to operate when presented the code by the user, including a time frame or set of time frames during which the code will allow access to the toilet. The code can include instructions to configure aspects of the toilet (e.g., lock, camera, sensors, fan, light, etc.) to user-customized specifications or to a configuration selected by a user from a group of preset configurations presented to the user by the system, or to a default configuration.

Once a code is assigned to a user, the system can identify the code as no longer available for assigning to access a particular toilet during a particular time. Once accessed using the assigned code, a respective reserved toilet (i.e., the lock and other devices in the reserved toilet) can likewise identify the code as a code that can be used to access the reserved toilet for a specified time or set of times associated with the user reservation as configured by the system. In this way, access to a reserved toilet can be secure and reserved for the user for a selected time or set of times and for a selected configuration (for example, selected sensors or devices can be made operable or inoperable as part of the user reservation).

Access codes can be stored on the lock and other devices of the toilet and on a system database on a server remote from a reserved toilet. The toilet, and/or the system can refresh, and/or synchronize access codes on the connected devices, such as the lock, with the server by periodically accessing the system server over a network, for example by wired or wireless connection via the internet or other network. Alternatively, access codes can be stored on the lock and other connected devices and the system server can assign codes to a user that match those on a connected device. Access parameters can be either pre-configured to a given code stored on a connected device or the server can provide additional instructions operable to configure a toilet and control access to a toilet that are acted on by a connected device once an access code has been presented to the connected device. In some embodiments, the connected device, such as a lock, can have no codes stored in its memory and instead can query the server over a network to validate an access code. In other embodiments, a secure key may be embedded as part of the access code that is verified via a matching key in the connected device (e.g., a lock).

Embodiments of the system, apparatus, and method can be purpose built and manufactured as part of a toilet enclosure or can be retrofitted onto existing toilet enclosures. In such retrofittable embodiments, the lock, connected devices, network components, can be provided as individual components or as a pre-configured group of components operable in accordance with the teachings. Similarly, additional connected components can be added to either purpose-built and retrofitted embodiments to enhance functionality and data collection. Retrofitted components can be configured to connect to and operate on the reservation system and application of the various embodiments in the manner previously described herein.

The application of the embodiments can also be operable to allow a user to provide feedback to the system indicating that service, stocking, or other maintenance such as cleaning is needed at the toilet. The system can then notify a human (e.g., via computer generated alert, email, text or similar means as may be known in the art) to send service personnel to correct the noted condition. In some embodiments, such user feedback can be used by the system to cause to operate a sanitizing device, such as a connected sprayer containing disinfectant or other cleaner, to sanitize the toilet enclosure and to place the toilet in and out of service (i.e., take it in and out of the available inventory that can be reserved by a user).

One embodiment is a toilet reservation and access system comprises an enclosable space, wherein the enclosable space contains a toilet, an entry to said enclosable space configured to allow a user to enter or leave the enclosable space, a lock having an open position and a locked position that can be cycled between the open and the locked positions for controlling use of the entry to access the enclosable space via the entry, a controller communicatively coupled to said lock and operable to cause said lock to cycle between the locked and open positions, wherein said controller is configurable to cause said lock to cycle during one or more preset schedules for an authorized user. The controller can be configured with such preset schedules via a wireless command, such as over a WIFI network, Bluetooth signal, cellular signal, NFC, RFID, or other such signals as known or developed in the art.

In some embodiments, the toilet includes a toilet lid and a manual or electrically driven lifting device operably connected to the toilet lid and operable to lift the toilet lid. For example, in one embodiment, the lifting device is a human powered lifting device, such as a foot-pedal driven device that lifts the toilet lid when the user presses down on the foot-pedal. In addition, or in the alternative, the lifting device comprises an electronic mechanism, such as a system that comprises a motor operatively coupled to the toilet lid, where the electronic system can be controlled to open or close the toilet lid. In some embodiments, a user application on a mobile device may be used to control opening or closing the toilet. Further, some embodiments can automatically open or close the toilet lid in response to receiving a valid access code (e.g., receiving the valid access from a mobile device, by scanning the valid access code from a physical device, or otherwise receiving the valid access code) or detecting other predefined trigger conditions.

Other embodiments can comprise a lock where the lock and controller are combined as a unit. The entry can be a standard type swing door on hinges suitable for the enclosure of which it is a part, and the enclosable space has four walls, or is an enclosure such as that of a port-a-potty as is known in the art. The enclosable space can thus, in some embodiments, have a floor, walls and a ceiling, where the entry is a door in one of the walls to allow access into and out of the enclosable space by a user. Further, the lock can be removable, and in some embodiments can be a mechanically actuated lock or an electronically actuated lock. Electronically actuated (e.g., cycled) locks can be actuated by an encoded keycard provided to the user, for example bearing a QR-code or other code, or by other types of wireless signal received by the lock controller, such as a WIFI signal, a Bluetooth signal, RFID signal, NFC signal, cellular signal, or other such wireless protocol signals. A QR code or electronic signal can be presented to the lock by a user by, for example, a mobile device such as a cellular phone. The lock and the controller can thus comprise a receiver, or a receiver and a transmitter, for receiving or receiving and transmitting such signals to control cycling of the lock and thus access to the enclosable space containing the toilet.

Embodiments of the system can further comprise a local area network (LAN) for providing a wireless signal to the controller to control cycling of the lock. The LAN can comprise one or more WIFI or one or more cellular modems and routers wirelessly connected to one or more controllers on one or more toilets in an enclosable space. The embodiments of the system can further comprise additional devices in the toilet enclosure such as a light, a fan, a level sensor to monitor toilet holding tank level, and one or more sensors configured to detect status of consumable supplies such as toilet paper and soap or cleaning agents.

Certain embodiments of the system can also include monitoring devices such as cameras, on the outside of the enclosure, and motion sensors configured to detect users and other people and activity in the area around the outside of the toilet. Such monitoring devices can be used to aid in determining access to the toilet and in providing security around the toilet. Other embodiments of the system can also comprise components to aid in the disinfection of a mobile restroom, such as a UVC light, spray disinfecting device, and a fogging or fumigation device, including the respective chemical disinfectant. All of the devices mentioned in this paragraph can be configured to provide an indication of their respective status or other indications programmed into the system (e.g., tank levels, supply level, inoperative status, speed of operation, detection of user presence). The indication provided can be visual or electronic (e.g., an email or other electronic signal to an operator), for example an onsite visual indicator such as a status light on the outside of the toilet enclosure, or a cellular, Bluetooth, WIFI, or another network signal to a remote monitor.

Electronic and other electrically powered, components can be powered via a typical electrical connection to a power grid (e.g., an electrical socket), or via a portable generator, or via solar cells that can be attached to the toilet enclosure, or via a battery power supply, where the batteries comprising the battery power supply can be charged by the solar cells, generator, or electrical connection to a power grid.

Embodiments can comprise a QR code reader or other reader for detecting a code or signal to operate the lock or other devices or functions associated with the toilet. For example, a user could have a badge encoded to operate components of the toilet such as the lock, or a mobile phone with a QR code (or a printout of such a code) or Bluetooth, NFC, or other such signal, all of which may be familiar to those in the art, including optical or other electronic means, including, in some embodiments, motion detection of pre-determined patterns (for example, a pre-designated hand, arm, leg or other body movement). In some embodiments, the user could have a preprogrammed tag on a shoe or other item of clothing, such as an event bracelet, for example to authorize entry into a toilet during a foot race or other sporting event.

Other embodiments of the system include a plurality of such toilets as described above, each configured to be located and reserved via an application, either on a mobile device or on another computer system, programmed to provide an interface for a user to locate and reserve a toilet for use. Such plurality of toilets can include the capability for a toilet, connected to a network, to announce itself and its status on a network accessible by such a user through the application. Such an application can allow a user to see the physical location of each of the toilets on the network, the status of each toilet (e.g., in use or not in use, future times reserved for use, when last cleaned, holding tank levels, type of toilet (e.g., single person, multi-person capacity, gender specific, size, amenities, and other such specifications), operational status of the toilet and of specific devices (e.g., lighting, fan, disinfection devices), cost to reserve each toilet, future availability of the toilets, user reviews, and other such information relevant to the user seeking to reserve a toilet. The application can also have the capability to take payment for reserving a toilet and providing the user with a code such as a QR code or other optical or wireless code, to either print ahead of time or to provide using the user’s mobile device (such as a phone, smartwatch, or other device capable of displaying or transmitting the access code) to allow the user to unlock and gain access to a reserved toilet at the reserved time or times.

Another embodiment is an apparatus for reserving and accessing a toilet comprising: a lock having an open position and a locked position that can be cycled between the open and the locked positions for controlling use of an entry to access an enclosable space containing a toilet via the entry, a controller communicatively coupled to said lock and operable to cause said lock to cycle between the locked and open positions, wherein said controller is configurable to cause said lock to cycle during one or more preset schedules for an authorized user. The lock can be fitted to an existing portable toilet, such as a porta-potty. The apparatus can further have the capabilities and added components as described for the system embodiments, all configurable to be retrofitted onto an enclosable space containing a toilet.

Still another embodiment is a method for reserving and accessing a toilet in an enclosable space comprising: providing an application that displays available toilets in a selected location, presenting said available toilets to a user of the application for said user to choose from, once a user selects an available toilet from the presented available toilets for a selected reservation time, reserving the selected toilet for the user by removing it from the list of available toilets that may be presented to the user or to any other user of the application for the selected reservation time, and providing the user an access code for unlocking a lock on the reserved toilet.

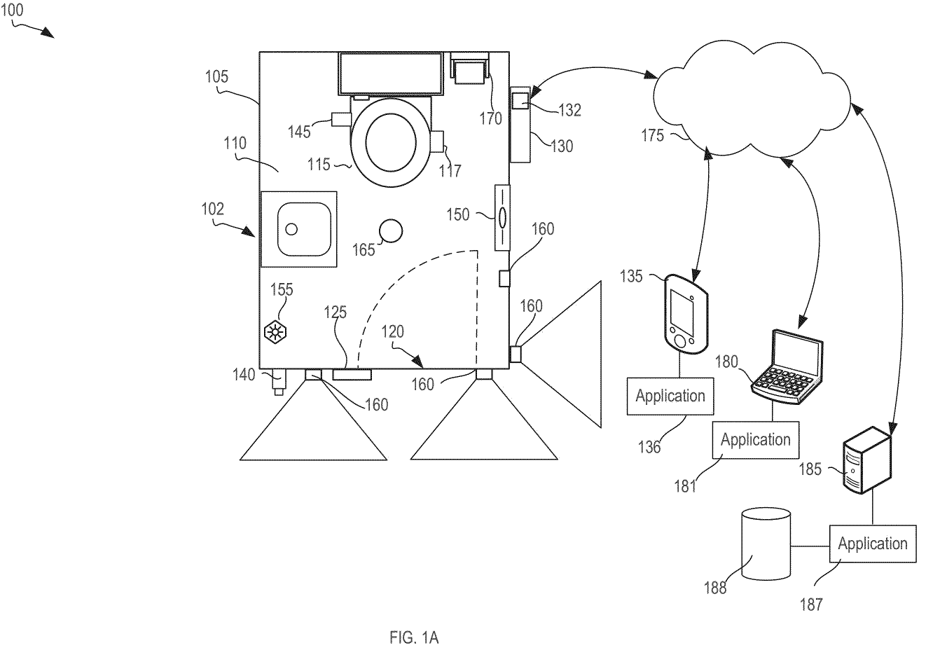

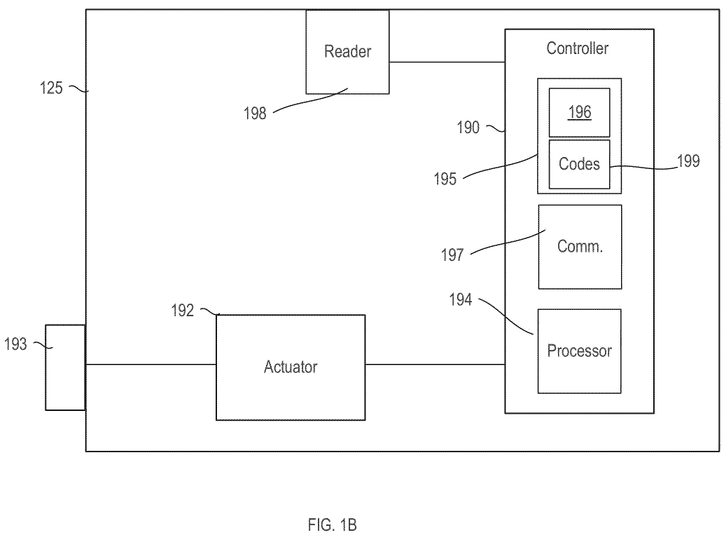

FIG. 1A is a diagrammatic representation of one embodiment of a reservation system 100 for reserving and accessing a portable toilet 102 or other type of toilet facility. According to one embodiment, portable toilet 102 is a chemical toilet with a plastic outer enclosure (cubicle) designed for easy transportation and temporary installation at outdoor venues, such as festivals or construction sites.

In system 100, a portable toilet 102 includes an enclosure 105 that defines an enclosable space 110 to provide privacy. In some embodiments, enclosure 105 is a unitary structure. In other embodiments, enclosure 105 comprises walls that are assembled together. Enclosure 105 can further comprise a floor and a ceiling (not shown). In some embodiments, enclosure 105 includes openings to promote airflow. A toilet 115 is located inside the boundary of enclosure 105. In some embodiments, toilet 115 is a smart connected toilet operable to measure, record, and transmit data such as number of uses, water/sewage level, and other measurable parameters.

In some embodiments, toilet 115 includes a toilet lid and a manual or electrically driven lifting device 117 operably connected to the toilet lid and operable to lift the toilet lid. For example, in one embodiment, lifting device 117 is a human powered lifting device, such as a foot-pedal driven device that lifts the toilet lid when the user presses down on the foot-pedal. In addition, or in the alternative, lifting device 117 comprises an electronic mechanism, such as a system that comprises a motor operatively coupled to the toilet lid, where the electronic system can be controlled to open or close the toilet lid.

Enclosure 105 comprises an entry 120 into the enclosable space 110. According to one embodiment, entry 120 comprises a door on hinges. Other types of entries allowing a human user to enter into enclosable 105 may also be used. Lock 125 is used to control access to the enclosable space. According to some embodiments, lock 125 is an electronically actuated lock capable of detecting and recognizing, for example, a secure QR code, Bluetooth signal, RFID signal, WIFI signal, Near Field ID (NFID) signal, cellular signal, or other such electronic or optical signal as may be known or developed in the art, including in some embodiments motion (e.g., a preset pattern of movement by a human or device), or a combination of these types of signals. Such a signal can be a signal generated by the lock itself and transmitted to detect and read data from another device or physical object (e.g., to read a printed symbol like a QR code, or read an RFID identifier from an RFID device).

Lock 125 is operably connected, by wired connection or wireless connection, by a transceiver 130 to a mobile device 135. A lock controller (e.g., controller 132 of transceiver 130, a controller in lock 125 or other controllers operatively coupled to lock 125) is operable to control lock 125 and cause lock 125 to cycle, for example, between a locked and an unlocked position to prevent or allow, respectively, access to enclosure 105, and thus to enclosable space 110. In some embodiments, mobile device 135 is operable to control lock 125 and cause lock 125 to cycle by, for example, providing appropriate signals to the lock controller.

Transceiver 130 and mobile device 135 can each comprise a cellular transmitter, WIFI transmitter, Bluetooth transmitter, RFID, NFC, Zigbee, Z-wave or other such wireless communication protocol for communicating between wireless devices. Transceiver 130 can be wirelessly or physically connected to lock 125 or other connected devices in or on enclosure 105, such as lifting device 117, camera 140, level sensor 145, fan 150, light 155, motion detector 160, disinfecting device 165 (such as a UV Light, sprayer, fogger, or fumigator), smart toilet paper holder 170, and toilet 115.

In some embodiments, transceiver 130 comprises or is connected to a controller 132 for operating lock 125 and the other connected devices of the embodiments. In other embodiments, lock 125 and some or all of the connected devices can be operable to directly communicate with network 175 (i.e., without a separate transceiver 130 or controller 132) and with each other to effectuate the actions and operations described above in accordance with the teachings of the present disclosure. In these embodiments, one or more of the connected devices can comprise a transceiver operable to connect the device, and in some embodiments, one or more of the other connected devices, to a network (e.g., network 175 or another network).

Lock 125 and the other connected devices of the embodiments can be operable to receive and transmit using wired or wireless protocols, such as, but not limited to, on one or more communications protocols such as WIFI, RFID, NFC, Bluetooth, and z-wave, or other communications protocols, to connect to transceiver 130, mobile device 135, or network 175 to transmit and receive information. According to some embodiments, the connected devices can thus provide data indicating operating status and other parameters such as use, power levels, liquid levels, motion, amount of toilet paper used and other such operating parameters. The connected devices are also operable to receive data from transceiver 130, mobile device 135, or network 175 to operate and control such connected devices.

As will be appreciated, portable toilets typically include a holding tank under or proximate to the toilet to hold waste. As such, a level sensor 145 is provided in some embodiments to measure the level of the holding tank.

Disinfection device 165 of the various embodiments can comprise a UVC light in the 200 - 280 nanometer wavelength range. Wavelengths between 185- 254 nanometers are considered germicidal because the short wavelength, high energy light can kill pathogenic microorganisms in the air and on surfaces. The UVC spectrum is the most efficient UV light spectrum for killing viruses and bacteria and will allow for the sanitization of air and surfaces in the toilet enclosure of the embodiments. Because time of exposure and proximity of a surface to the UV light source determine the effectiveness of UV light sterilization, it is contemplated that the embodiments can be configured to illuminate a UVC light embodiment of disinfection device 165 for between 5 to 20 minutes, depending on the UVC power rating. For example, disinfecting device 165 can comprise a 60-watt UVC light source for which a preferred illumination time for disinfection may be between 5 to 10 minutes for a 50 sq-ft toilet enclosure. Embodiments can be configured for larger or shorter desired illumination (exposure) times of a UVC light embodiment of disinfecting device 165 depending on the power rating of the UVC light and the floor area of the toilet enclosure 105, and the degree of sterilization desired. In many cases a lower power (e.g., 15 watt) UVC light source and longer exposure time may be sufficient for sterilization of a small enclosable space, whereas in some instances a more powerful UVC light source and shorter exposure time may be desirable (e.g., for high use situations or larger toilet enclosable spaces 105).

In some embodiments, disinfecting device 165 can comprise a UVC light source mounted on a directional support that can be configured to change the direction of the UVC light from the UVC light source to illuminate more, or all, of the surfaces within toilet enclosure 105. Such movement can be configured to be rotational, randomized, or any such pattern effective to illuminate the surfaces of toilet enclosure 105 to obtain a desired level of sterilization. Other disinfecting devices 165 (e.g., sprayer, fogger, or fumigator) can likewise be mounted on such a directional support. Disinfecting device 165 can be configured to be manually operated, turned on and off by a user using an application (e.g., on mobile device 135), or to be cycled on and off on a preset schedule or preset trigger, such as by a user cycling lock 125 between locked and open positions, by a motion detector 160 sensing movement or no movement within toilet enclosure 105 for a preset period of time (turn disinfecting device 165 on for lack of movement, off when sensing movement), or by a combination of such triggering events. For safety reasons, disinfecting device 165 can be configured to not turn on when toilet enclosure 105 is occupied by a user or other person. Embodiments are also contemplated to use combinations of disinfecting device 165 with manual or other physical cleaning of toilet enclosure 105 and with fan 150 to help remove unpleasant odors or other byproducts of the disinfecting process associated with the different embodiments of disinfecting device 165.

Transceiver 130 and mobile device 135 can comprise a receiver to receive on one or more wireless protocols. Transceiver 130 and mobile device 135 are operably connected wirelessly to a network 175, which can be the internet, a cellular network, a LAN, or a WAN or a combination thereof. Network 175 is operably connected to one or more other networked devices 180 and one or more servers 185. Although networked device 180 is shown as a personal computing device in system 100, it can also be a mobile device (e.g., a table or smartphone), hardwired device, other wirelessly connected device, or any other device capable of connecting to a network to transmit and/or receive data.

According to one embodiment, server 185 of system 100 comprises system software 187 that provides an application backend for a reservation application. The user facing aspect of the reservation application can be hosted on a mobile device 135 (e.g., user application 136) or networked device 180 (e.g., user application 181). Thus, in some embodiments, a reservation application includes an application backend and an application frontend. The reservation backend provided by system software 187 handles requests to reserve portable toilets (e.g., portable toilet 102) or other toilets from users using an application frontend on mobile devices or other devices (e.g., application 136 devices or application 181), or, in some embodiments, from a verbal reservation made over a telephone, either through an automated system or by communicating the reservation request to a service representative.

The reservation application is executable to allow a user to, for example, access server 185 to locate relevant toilets, determine their availability at a particular time, choose among a set of relevant toilets, and reserve a toilet to be accessed at a scheduled time. According to one embodiment, the reservation application is executable to allow a user to reserve an individual toilet for a set period of time, allow a user to reserve access to a group of toilets for a set period of time (i.e., the user can unlock and access any available toilet of such a group of toilets), or allow a user to purchase a subscription allowing access to an individual toilet or group of toilets over a longer set period of time (e.g., a weekly, monthly, or yearly subscription of a larger group of toilets). In addition, or in the alternative, the reservation application is executable to allow a user to select and purchase access to a toilet on an ad hoc basis, such as by using the application to locate available toilets nearby when nature calls, and then selecting and purchasing access to an available toilet for a single use of the access code.

The reservation application, in some embodiments, is executable to allow a user to reserve a toilet as part of a third-party reservation. For example, a user can purchase tickets to an event (e.g., a concert through an online ticket broker) and be presented the option to purchase a toilet reservation for the event. If the configuration of available toilets for the event is known at the time of reservation, the user is presented with a list of available toilets that can be reserved. If the configuration is not yet known, the user can instead purchase a right to reserve once the configuration is known or can purchase access and allow the system to assign a toilet or group of toilets once the configuration is known. In either case, the user can be provided an access code at the time of purchase or sent an access code or a device (such as an event bracelet) having an access code at a later date prior to or at the event.

In some embodiments, the user may also select other reservation parameters, such as whether to turn on a fan (e.g., fan 150), disinfect the toilet, or turn on a light, for the reservation.

In any case, a user is provided with an access code to access a toilet for a reserved time (toilet/date/time)—as will be appreciated a date/time may include a block of dates or times. In some cases, the access code may be usable for multiple reserved times. In other embodiments, an access code is unique to a particular toilet/date/time combination. An access code can be provided by the user to the lock (e.g., lock 125) via a dedicated device (such as a physical tag encoded with the access code or a printout with an access code that can be optically detected and recognized) or via a device (such as a mobile device 135) capable of displaying or transmitting an access code in a format the lock can recognize.

As discussed, in some embodiments, the user can provide an access code to a lock (e.g., lock 125) using a mobile device. For example, user application 136 is executable, in some embodiments, to receive an access code from server 185 and provide the access code to the reserved toilet, for example once the user is near the toilet, to allow access at the scheduled time or event under a set of conditions selected by the user when reserving the toilet. In some embodiments, access is allowed at any time during a time block reserved by a user. In other embodiments, access allowed within a specified time range of the start time selected by the user for the reservation. In some embodiments, server 185 is operable to provide an access code or other electronic key to the user, where the electronic key (e.g., access code) is configured to open the lock and configure the toilet based on a set of pre-existing conditions on the lock (i.e., without the need, in some embodiments, for the server to send any data to the lock over the network to enforce the reservation).

The reservation application is executable, in some embodiments, to allow the user to control, in addition to the lock, other connected devices, such as turning a fan or light on and off, activating disinfection devices for disinfecting the restroom, automatically lifting the toilet seat or viewing the feed from external cameras on the toilet enclosure prior to exiting the toilet enclosure to determine if any person or other potential threat is outside of the toilet.

An access code or codes provided to a user by the embodiments of the system can be generated and/or stored in a database 188 on a system server 185 in such a way that the codes in the database match codes on a lock or other connected device of a reserved toilet (e.g., portable toilet 102). Once a user reserves a toilet and the reservation application provides the user an access code, that code can be matched to an appropriately configured toilet. In some embodiments, the access code itself contains information to configure the toilet to user-selected specifications.

According to one embodiment, the lock on a toilet (e.g., lock 125) or a lock and a central system database (e.g., lock 125 and database 188) can be configured with a preset set of codes that the reservation application can select from and assign to a user when the user reserves a toilet. When a user reserves a toilet (either a pre-configured toilet or a user-configured toilet), the reservation application assigns an access code to the user that will operate the lock and other devices on the selected toilet. In some embodiments, the access code includes instructions to cause lock 125 and other connected devices in portable toilet 102 to operate when presented the code by the user, including a time frame or set of time frames during which the code will allow access to the toilet. The code can include instructions to configure aspects of the toilet (e.g., lock, camera, sensors, fan, light, lid, etc.) to user-customized specifications or to a configuration selected by a user from a group of preset configurations presented to the user by the system, or to a default configuration.

In operation, a user accesses a user application 136 on a mobile device 135 or a user application 181 on a networked device 180. The user application can then present, for example, a catalog of available toilet options, at different dates, times, and locations and at varying levels of amenities. In some embodiments, unavailable toilets may also be displayed with an indication that the toilets are reserved or otherwise unavailable for a date/time/location. The user selects a toilet to reserve and the user application communicates the user’s request from mobile device 135 or networked device 180 through network 175 to server 185 hosting the system software 187. In some embodiments, server 185 is a cloud-based server. In other embodiments, server 185 is a discrete server, or other type of server. The user application 136, 181 in some embodiments, is an application specifically for use with the reservation system. In other embodiments, the user application is an application, such as a web browser, that can access the reservation application via a web site.

The hosted system software 187 of server 185 updates the catalog of available toilet options, for example taking the toilet requested by the user out of the available catalog for the requested date, time, and location to prevent other users from reserving it at the same time. The hosted software then provides the user, prior to the reserved time, an access code that the user can present at the requested toilet at the requested time to control lock 125 and gain access to enclosure 105. The system software 187 can also, prior to the requested time, provide to transceiver 130 operating instructions operable to be provided to lock 125 and cause lock 125 to recognize and respond to the access code provided to the user, including in some embodiments, additional reservation parameters such as whether light 155 should be on or off, whether fan 150 should be on or off, whether to activate disinfection devices for disinfecting the restroom, whether to lift the toilet seat.

Once reserved, a user can operate lock 125 and access enclosure 105 by using the access code provided for the reservation. In some embodiments, user application 136 is executable to display the access code (e.g., in the form of a QR code, bar code or other code that can be read by lock 125) or to transmit a wireless signal (e.g., RFID signal, Bluetooth signal, NFC signal) that includes the code to lock 125. In addition, or in the alternative, a user can be provided a printed access code (such as a QR code), or a physical device (not shown) containing an access code that the user can present to lock 125 to operate lock 125 and gain access to enclosure 105. For example, the user can be provided, prior to the time of reservation, an event bracelet or other token, operable to operate lock 125 using a wireless communications protocol. In some embodiments the physical device provided to the user can be a device such as a USB drive or other device that can be mechanically and/or electrically connected to lock 125.

The user application 136 of some embodiments can be operable to allow a user to control, during the time the user has reserved a toilet in accordance with the teachings of this invention, the various connected devices in, on, and around enclosure 105. For example, the user can control the fan 150, light 155 and toilet seat through the application on a mobile device 135 to turn the fan and light on prior to entry into enclosure 105 or lift or close the toilet seat. Similarly, a user can access camera 140 to determine if there are other people and or safety concerns near to enclosure 105, both before arriving at the reserved toilet enclosure 105 and, after use of toilet 115, before opening entry 120 and exiting enclosure 105. In some embodiments, the user has the ability to disinfect the toilet through the application on a mobile device.

FIG. 1B is a diagrammatic representation of one embodiment of a connected lock, such as lock 125 of FIG. 1A. Lock 125 comprises a controller 190 that controls an actuation mechanism 192 that actuates a locking mechanism 193 to lock and unlock entry 120. In operation, controller 190 locks or unlocks the portable toilet in response to a signal initiated by, for example, a user command from a user application on, for example, a mobile device, or an access code provided by a mobile device, physical device, or other device.

In some embodiments, locking mechanism 193 is a simple mechanical pawl, dead bolt, rotating lock plate, or other locking mechanism, moved from one position to another by actuation mechanism 192 to cycle lock 125 between a locked and unlocked position. According to one embodiment, actuation mechanism 192 is a linear or rotary actuator driven by an electric motor for cycling a locking mechanism 193 between a locked position and unlocked position. In some embodiments, actuation mechanism 192 comprises a magnetic mechanism, for example a solenoid, that cycles locking mechanism 193 between a locked and unlocked position.

Controller 190 includes a processor 194, a memory 195, and controller code 196 (e.g., software) resident in the memory, for receiving and processing the access code and other signals, and to cause actuation mechanism 192 to cycle locking mechanism 193 between a locked position and unlocked position.

Controller 190 includes communications interfaces 197 to receive wired or wireless signals from server 185, mobile device 135, or networked device 180 either directly from network 175 or from transceiver 130. In addition, controller 190, in some embodiments, includes communications interfaces 197 to receive signals directly from a user’s mobile device 135. By way of example, but not limitation, controller 190 may include interfaces to communicate with transceiver 130 or receive access codes from mobile devices via a wireless signal such as WIFI signal, a Bluetooth signal, RFID signal, NFC signal, cellular signal, or other such wireless protocol signals. Further, controller 190 can include a communications interface 197 to send signals to and receive signals from actuation mechanism 192.

Processing by controller can include validating access codes. In some embodiments, memory 195 stores access codes 199. Access codes can be stored on the lock and other devices of the toilet and on a system database on a server remote from a reserved toilet (e.g., database 188). Controller 190 or server 185 can refresh, and/or synchronize access codes on the connected devices, such as lock 125, with server 185 by periodically accessing server 185 over a network, for example by wired or wireless connection via the internet or other network.

Alternatively, access codes can be stored on lock 125 and server 185 can assign codes to a user that match those on lock 125. In some embodiments, access parameters are pre-configured on lock 125 to a given access code 199 stored on controller 190. For example, controller 190 may be pre-configured with a schedule for each access code 199, where the schedule specifies the date(s) and time(s) that the access code is valid. Thus, when a user reserves the toilet for a date and time, server 185 can assign an access code to the reservation that matches the access code 199 pre-configured on lock 125 for that date and time. In other embodiments, server 185 can provide additional instructions operable to configure a toilet and control access to a toilet that are acted on by controller 190 once an access code has been presented to lock 125. For example, server 185 provides, to controller 190, a schedule of when an access code 199 matching an access code assigned to a user is valid. In some embodiments, the schedule for the access code is encoded as part of the access code. In some embodiments, controller 190 has no access codes stored in its memory 195 and instead controller 190 queries server 185 over network 175 to validate an access code. In other embodiments, a secure key may be embedded as part of the access code that is verified via a matching key in controller 190.

In some embodiments, controller 190 receives signals from wired or wirelessly connected I/O devices 198, such as, but not limited to a wireless code reader (e.g., QR code reader, bar code reader, RFID reader, NFC reader or other reader) located on lock 125 or elsewhere on enclosure 105 for detecting a code or signal to operate the lock or other devices or functions associated with the toilet. In some embodiments, the code reader is connected by a wired or wireless connection to the controller 132 of transceiver 130 and transceiver 130 provides the access code to lock controller 190.

When an access code is received and validated, lock 125 can be unlocked in response to the user providing the access code. Similarly, controller 190, after validating the access code, is operable to receive and process additional signals (e.g., from a user’s portable device) to operate and control other connected devices in a toilet (e.g., toilet enclosure 105 of FIG. 1A) as described herein.

In some embodiments, controller code 196 is executable to send a signal to server 185 or other system to indicate a use of the toilet has been completed (as can be determined an increase in the level detected by a level sensor 145) that can then be used by such a system to predict servicing and maintenance of the toilet and can trigger the system to place the toilet back into the inventory of available toilets that can be reserved by a user.

While controller 190 is illustrated as part of lock 125 in FIG. 1B, the functionality of controller 190 may be otherwise implemented elsewhere in system 100. By way of example, but not limitation, all or portion of the functionality discussed with respect to controller 190 may be implemented in controller 132 of transceiver 130 or at another controller.

Furthermore, while FIG. 1A depicts a portable toilet 102, mobile device 135, networked device 180, and server 185, a system 100 may include any number of portable toilets (or other toilets), mobile devices, network devices and servers. Moreover, as will be appreciated, each mobile device 135, networked device 180 and server 185 can comprise processors, computer-readable memories, I/O devices, communications interfaces and other hardware components and can store computer-executable instructions that are executable to carry out various operations described herein.

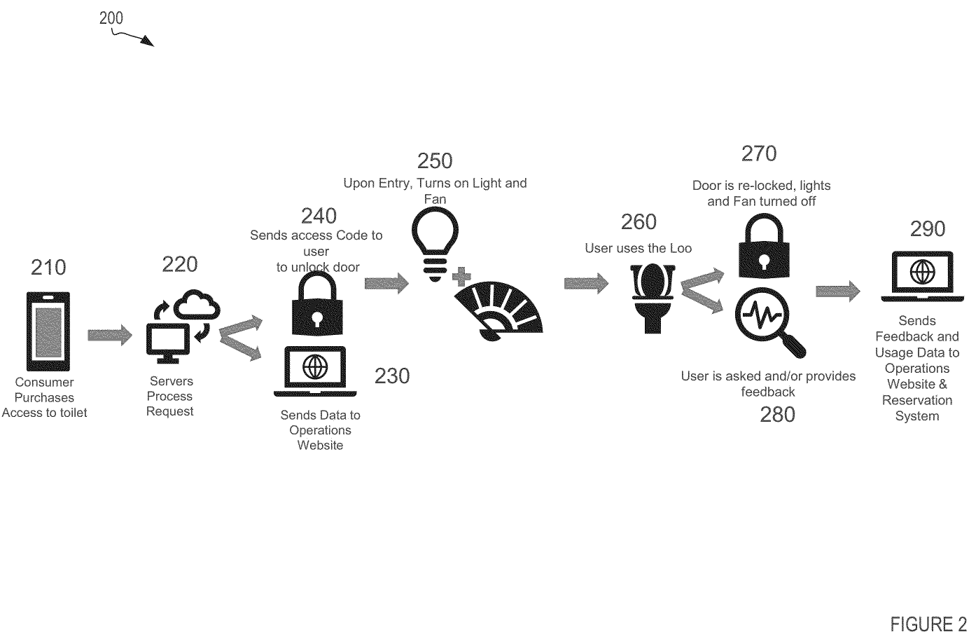

FIG. 2 is a logic flow diagram illustrating one embodiment of a method 200 for reserving a toilet. Various steps of method 200 can be embodied as computer-executable code stored on a computer readable medium and executable by processor at a controller (e.g., controller 190, controller 132), a mobile device (e.g., mobile device 135), a networked device 180 (e.g., networked device 180) a server (e.g., server 185), or other computer system.

Method 200 begins at step 210 where a user accesses a reservation application by using a user application (e.g., user application 136, user application 181). The user, at step 210, interacts with a user application to reserve a toilet at a particular date, time, and location by selecting from a catalog of available toilet options. The user’s reservation selection is communicated to the reservation server hosting the reservation software (e.g., server 185 in FIG. 1A) where, at step 220, it is received and processed, reserving the selected toilet for the user by removing the selected toilet from the catalog of available toilets for the selected date and time and location.

At step 230, data relating to the user’s reservation is provided to an operations system or website for an operator of an event or facility where the reserved toilet will be located and available on the selected date and time. At step 240, the reservation software provides an access code to the user, such as a QR code or other electronic access code. The access code can be provided prior to the time of the user reservation via an email, a text, other electronic communications, or by providing a physical object containing the access code, such as a mailed or faxed printed QR code, or an event bracelet, USB device, RFID badge, NFC tag, or other such device that can be presented to a lock, such as lock 125 of FIG. 1A, for access to a toilet enclosure. The user can present the access code to an optical or other electronic reader of an embodiment located on, for example, the lock 125 or enclosure 105 of the embodiment of FIG. 1A.

At step 250, a user can provide the access code at the toilet as described above to operate the lock, which is validated by lock 125 to allow entry. As discussed above, lock 125 may be pre-configured with the access codes for time slots or may query the server for the access codes. Providing the access code can also turn on connected devices such as a light, fan, a camera, disinfection device, etc., such as shown in FIG. 1A. Further, a user can use a mobile device to control connected devices as disclosed above in the description of FIG. 1A.

At step 260 a user uses the toilet. At step 270, a user exits the toilet enclosure and locks the toilet enclosure. In some embodiments, the user can turn the lock to a locked position manually or via the application on a mobile device or by using a physical device containing the access code. The embodiments of the system and method can also automatically control the lock to secure entry into the enclosure after a set period of time and by detecting whether there is anyone in the enclosure, for example via a motion detector or camera such as disclosed in FIG. 1A. In a similar manner, the other connected devices of the embodiments can be controlled to either power down after a set period of time, or power up for a set period of time and then power down (e.g., the fan to clear the enclosure of unpleasant odors).

At step 280, the user can be prompted for feedback and provide feedback to the reservation software of the embodiments. Such feedback can comprise rating of the cleanliness and amenities of the toilet and feedback as to desired maintenance or reporting of non-operational or defect functions and features of the toilet. At step 290, the feedback is provided to the reservation system of the embodiments for processing and analysis to allow for predictive functions such as future maintenance and stocking, and for analysis of usage trends, reservation trends, capacity needs, among others, and analysis of the demographics associated with reservations. Subsets of this same information can be provided at step 290 to the operations system of the event or facility operator where the toilets are located.

FIG. 2 is provided by way of example and not limitation. Various steps may be repeated, steps may be performed in different orders, steps omitted, and additional or alternative steps performed.

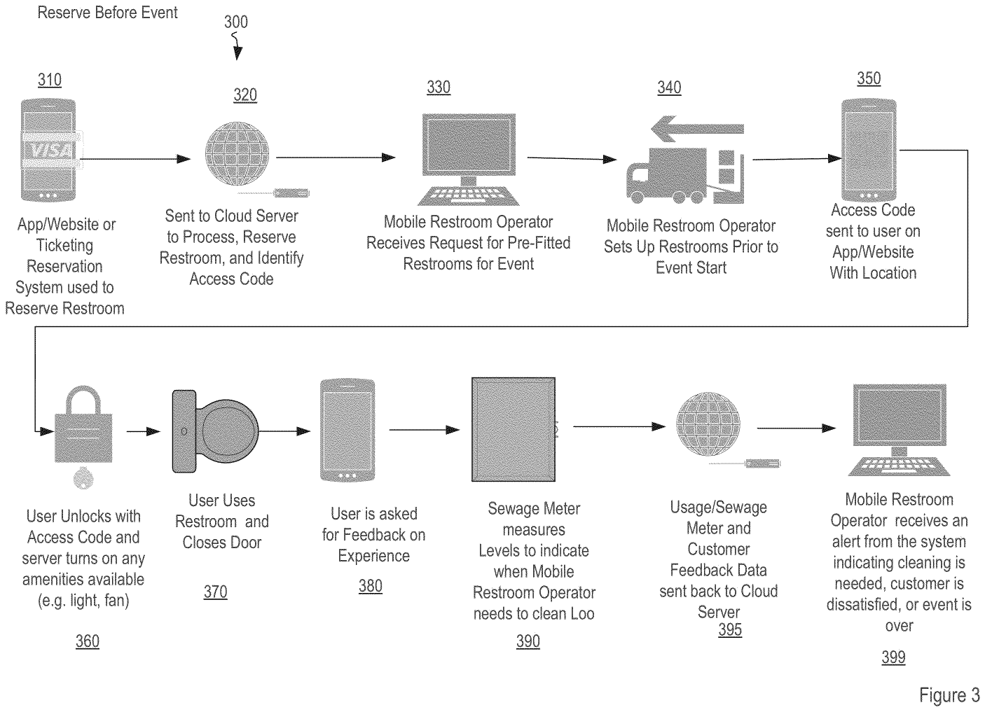

FIG. 3 is a logic flow diagram illustrating one embodiment of a method 300 for reserving a toilet in advance of an event, accessing the toilet, and monitoring the toilet. Various steps of method 300 can be embodied as computer-executable code stored on a computer readable medium and executable by processor at a controller (e.g., controller 190, controller 132), a mobile device (e.g., mobile device 135), a networked device 180 (e.g., networked device 180) a server (e.g., server 185), or other computer system (e.g., a ticketing reservation system).

At step 310, a user accesses a reservation application via a mobile application, a website, or other mechanism, and reserves a toilet. In some embodiments, the user makes the reservation through a ticketing reservation system provided by a ticket broker as, for example, a step in purchasing tickets. At step 320, the user request is communicated over a network to the reservation system backend (e.g., server 185 in the embodiment of FIG. 1A) where the user reservation request is processed, and the toilet reserved and removed from the catalog of available toilets for that particular place and time. In some embodiments, where a user reserves access to any available toilet within a group of toilets, the system and method of the embodiments can process this request in a similar manner but instead of removing the toilet from the catalog of available toilets can instead track the number of users making such a reservation in a group of toilets and remove the group of toilets from the catalog of available toilets once a set number of users has reserved access to the group of toilets. The user is then provided an access code in accordance with the teachings as previously described. It can be noted that a toilet or group of toilets removed from the catalog of available toilets may still be displayed to users of the reservation system, but can be indicated as reserved.

At step 330, an aggregate number of all reservation requests for an event are provided to an operator that will provide the toilets for the event. The operator can, with this information, configure and provide the required toilets needed to satisfy the reservation requests for the event. At step 340, the event or facility operator sets up the toilets prior to the event and at step 350, which can be at any time prior to or at the time of the event, access codes are provided, as previously described, to the user(s) that reserved toilets.

Setup of toilets to meet reservations is accomplished by the operator considering aminimum number and type of toilets matched to meet reservation demand. The operator will add some amount of surplus toilet capacity (e.g., 0-20%) to account for breakdowns, maintenance intervals, or added reservations occurring during an event. The amount of surplus can be based on historical data from the same or similar events, expected attendance, weather conditions, available event space, etc. In a similar manner, the operator will determine placement of toilets, taking also into account available electrical power, water connections, network interfaces, storage for maintenance and resupply items, and similar considerations.

At step 360, a user accesses a reserved toilet using an access code, uses the toilet (step 370) and exits the toilet enclosure. In some embodiments, the user can lock the enclosure manually, via the application on a mobile device or using a physical device containing the access code. The embodiments of the system and method can also automatically control the lock to secure entry into the enclosure after a set period of time and by detecting whether there is anyone in the enclosure, for example via a motion detector or camera such as disclosed in FIG. 1A. In a similar manner, the other connected devices of the embodiments can be controlled to either power down after a set period of time, or power up for a set period of time and then power down (e.g., the fan to clear the enclosure of unpleasant odors).

The user is asked for and provides feedback at step 380. At step 390, which occurs continuously throughout the event, a level indicator, such as level sensor 145 of the embodiment described in FIG. 1A, measures levels in the toilet’s holding tank to determine when the toilet needs to be emptied and cleaned. At step 395, level indicator data and user feedback are provided over a network to the reservation system backend (e.g., server 185 in the embodiment of FIG. 1A), which processes and analyzes the data.

At step 399, the reservation system provides data and alerts to the event or facility operator, which can be data derived from the data received from the connected devices and user feedback. This data can comprise alerts to the operator that toilets need cleaning or other maintenance, feedback from users, or an indication that the toilets are no longer in use (e.g., because the event is over), or other data. The toilet operator for an event or facility can be different than the operator of the reservation system and method, and in fact it is anticipated that often this will be the case as the reservation system provider provides the reservation aspects as a service to the operator of an event or facility.

Embodiments provide enhanced efficiency for a mobile restroom operator to know when servicing or maintenance of a toilet is needed, both through customer feedback and through autonomous and automated alerts from connected devices capable of monitoring various parameters, such as tank level, and communicating this information to an operator over a communications network.

FIG. 3 is provided by way of example and not limitation. Various steps may be repeated, steps may be performed in different orders, steps omitted, and additional or alternative steps performed.

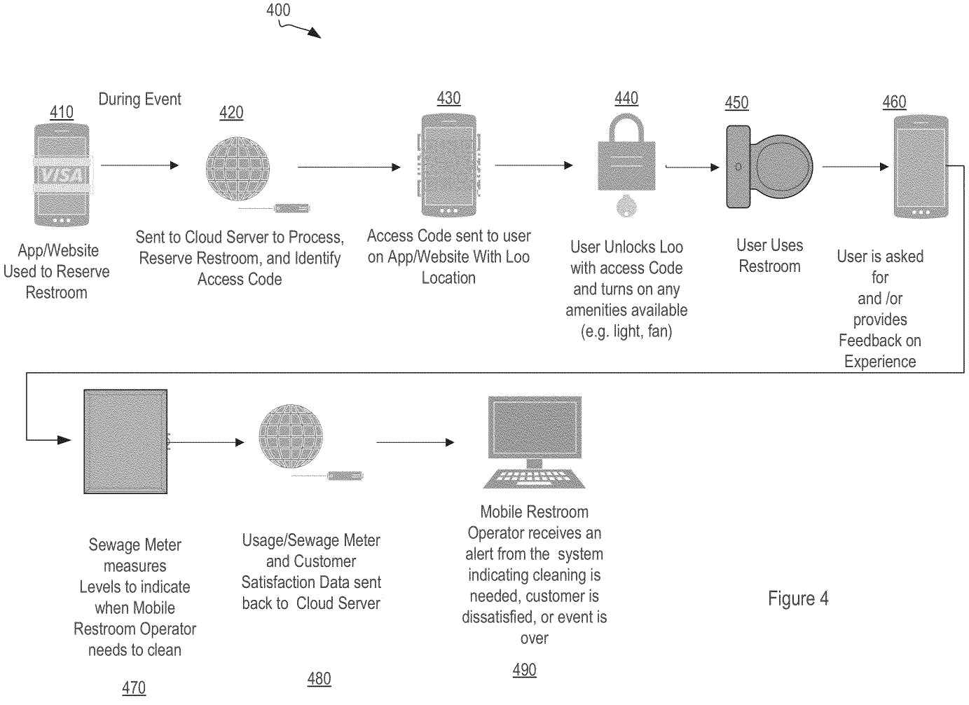

FIG. 4 is a logic flow diagram illustrating one embodiment of a method 400 for reserving access to a toilet, accessing the toilet and monitoring the toilet. Various steps of method 400 can be embodied as computer-executable code stored on a computer readable medium and executable by processor at a controller (e.g., controller 190, controller 132), a mobile device (e.g., mobile device 135), a networked device 180 (e.g., networked device 180) a server (e.g., server 185), or other computer system.

More particularly, method 400 illustrates one embodiment reserving a toilet in “real-time”, for example, when toilets are on-site and physically available at an event or facility, but a potential user who needs a toilet did not reserve a toilet prior to the event. In this example the user, at step 410, accesses a reservation application via a mobile application, a website, or other mechanism, and reserves a toilet. At step 420, the user request is communicated over a network to the reservation system backend (e.g., server 185 in the embodiment of FIG. 1A), where the user reservation request is processed, and the toilet reserved and removed from the catalog of available toilets for that place and time. At step 430, the reservation software sends an access code to the user (for example, to the user’s mobile device). The specific toilet location can also be provided to the user, for example if the user reserves the nearest available toilet or the soonest available toilet.

The user unlocks the toilet using the access code (step 440), uses the toilet (step 450), and exits the toilet enclosure. In some embodiments, the user can lock the enclosure manually, via the application on a mobile device or using a physical device containing the access code. The embodiments of the system and method can also automatically control the lock to secure entry into the enclosure after a set period of time and by detecting whether there is anyone in the enclosure, for example via a motion detector or camera such as disclosed in FIG. 1A. In a similar manner, the other connected devices of the embodiments can be controlled to either power down after a set period of time, or power up for a set period of time and then power down (e.g., the fan to clear the enclosure of unpleasant odors).

The user is asked for feedback and provides feedback (e.g., no feedback can also be usable feedback data) (step 460). Data from connected devices is collected by a controller at the toilet (step 470). For example, a level indicator, such as level sensor 145, measures levels in the toilet’s holding tank to determine when the toilet needs to be emptied and cleaned.

Data from the user and connected devices is provided to the reservation system backend (e.g., server 185 in the embodiment of FIG. 1A) (step 480), which processes and analyzes the data. The reservation system provides data and alerts to the event or facility operator, which can be data derived from the data received from the connected devices and user feedback (step 490). The data sent to the operator may include, for example, alerts that toilets need cleaning or other maintenance, feedback from users, or an indication that the toilets are no longer in use (e.g., because the event is over).

FIG. 4 is provided by way of example and not limitation. Various steps may be repeated, steps may be performed in different orders, steps omitted, and additional or alternative steps performed.

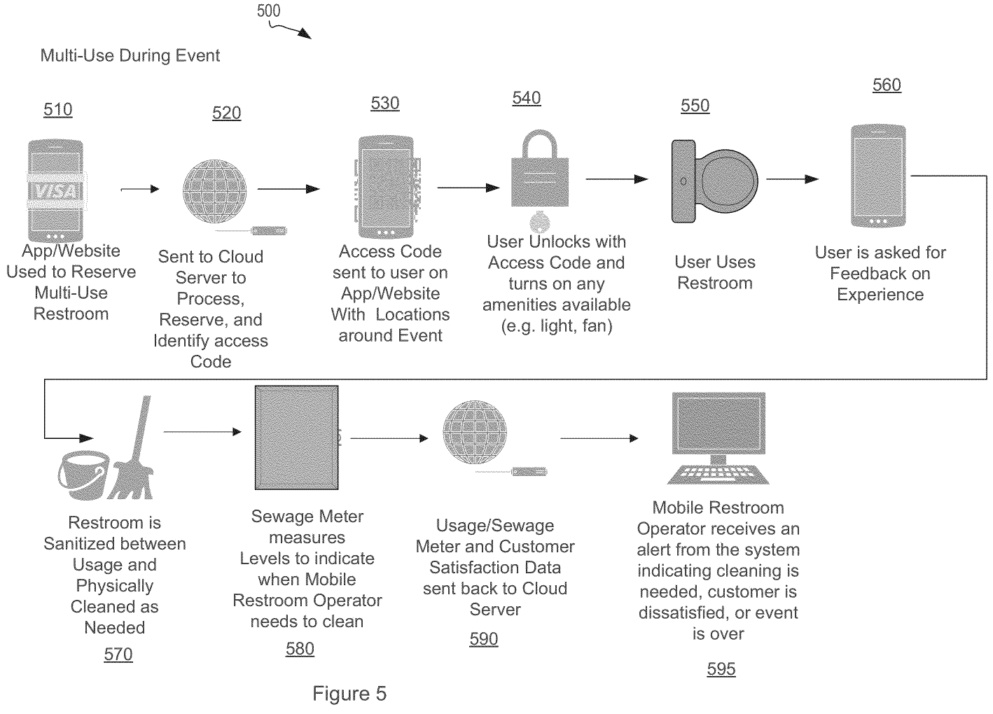

FIG. 5 is a logic flow diagram illustrating one embodiment of a method 500 for reserving access to a toilet in a 'real-time" situation, accessing the toilet, and monitoring the toilet. Various steps of method 500 can be embodied as computer-executable code stored on a computer readable medium and executable by processor at a controller (e.g., controller 190, controller 132), a mobile device (e.g., mobile device 135), a networked device 180 (e.g., networked device 180) a server (e.g., server 185), or other computer system.

In a manner similar to that disclosed with reference to the embodiment of FIG. 4, where toilets are physically present and available for reservation and use at an event or a facility, a user, at step 510, reserves a toilet. In this example embodiment, however, the user requests and reserves access to any available toilet within a specific group or category of toilets. At step 520, the user request is communicated over a network to the server-hosted reservation application, where the user reservation request is processed.

At step 530, the reservation system provides the user with an access code that can be used to access any of a set number of toilets in a particular group and/or category of toilets. This group or category of toilets can be physically grouped together or located in locations throughout an event and facility. The reservation system also provides, at step 530, a listing, map, or a link to a map, indicating the locations of the toilets the user can access. The user, via the application of the various embodiments, can also be provided status information for the toilets in the group or category of toilets to which the user has reserved access.

The user unlocks the toilet using the access code (step 540), uses the toilet (step 550) and exits the toilet enclosure. In some embodiments, the user can lock the enclosure manually, via the application on a mobile device or using a physical device containing the access code. The embodiments of the system and method can also automatically control the lock to secure entry into the enclosure after a set period of time and by detecting whether there is anyone in the enclosure, for example via a motion detector or camera such as disclosed in FIG. 1A. In a similar manner, the other connected devices of the embodiments can be controlled to either power down after a set period of time, or power up for a set period of time and then power down (e.g., the fan to clear the enclosure of unpleasant odors).

The user is asked for feedback and provides feedback (e.g., no feedback can also be usable feedback data) (step 560). At step 570, the operator responsible for the toilets at the event or facility is provided feedback indicating that a user has used a toilet, along with any feedback from the user as to conditions of the toilet that require attention. Based on this information, the operator can clean the toilet after each use, after a set number of uses, or based on feedback from the user. In some embodiments, the toilet is automatically sanitized, for example by spraying disinfectant, following use. Automatic sanitization and cleaning can be controlled based on user feedback or upon detection that a user has exited the toilet as detected by the connected devices of the embodiments.

Data from connected devices is collected by a controller at the toilet (step 580). For example, a level indicator, such as level sensor 145, measures levels in the toilet’s holding tank to determine when the toilet needs to be emptied and cleaned.

Data from the user and connected devices is provided to the reservation system backend (e.g., server 185 in the embodiment of FIG. 1A) (step 590), which processes and analyzes the data. The reservation system provides data and alerts to the event or facility operator, which can be data derived from the data received from the connected devices and user feedback (step 595). The data sent to the operator may include, for example, alerts that toilets need cleaning or other maintenance, feedback from users, or an indication that the toilets are no longer in use (e.g., because the event is over).

FIG. 5 is provided by way of example and not limitation. Various steps may be repeated, steps may be performed in different orders, steps omitted, and additional or alternative steps performed.

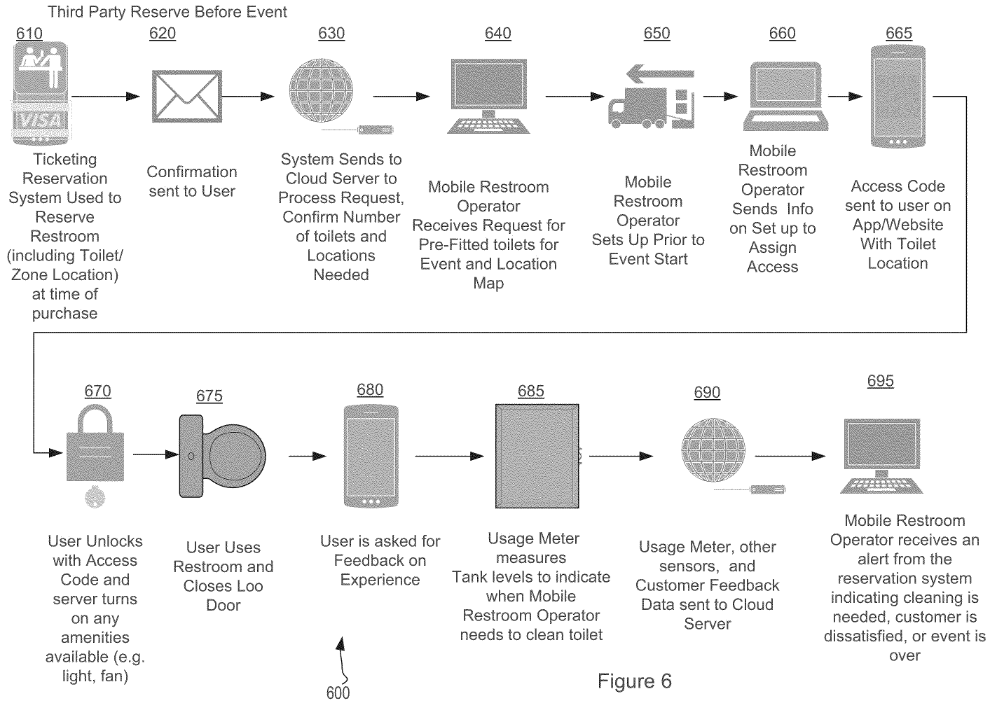

FIG. 6 is a logic flow diagram illustrating one embodiment of a method 600 for reserving access to a toilet in advance of an event, accessing the toilet, and monitoring the toilet. Various steps of method 600 can be embodied as computer-executable code stored on a computer readable medium and executable by processor at a controller (e.g., controller 190, controller 132), a mobile device (e.g., mobile device 135), a networked device 180 (e.g., networked device 180) a server (e.g., server 185), or other computer system.

More particularly, FIG. 6 illustrates an embodiment in which a user receives a confirmation at the time of reservation and where the reservation system is operable to integrate with and communicate with the systems of an event ticketing operator and/or a mobile restroom operator, which can be different than the systems of the reservation system provider.

At step 610, a user uses a ticketing reservation system to reserve a restroom. and selects a toilet to reserve. At step 620, the ticketing reservation system provides the user with a confirmation of their reservation, which can be in the form of an email, text, or other electronic communication. At step 630, the ticketing reservation system communicates the user request over a network to the reservation system backend (e.g., server 185 in the embodiment of FIG. 1A), where the user reservation request is processed, and the toilet reserved and removed from the catalog of available toilets for that place and time. In some embodiments, where a user reserves access to any available toilet within a group of toilets, the reservation system processes this request in a similar manner, but instead of removing the toilet from the catalog of available toilets, the reservation system tracks the number of users making such a reservation in a group of toilets and removes the group of toilets from the catalog of available toilets once a set number of users has reserved access to the group of toilets. The reservation system of the embodiments can interface with and/or be accessed by the ticketing reservation system, which can be a third-party ticketing reservation system, or can be part of the reservation system.

At step 640, an aggregate number of all reservation requests for an event are provided to a mobile restroom operator that will provide the toilets for the event. The operator can, with this information, configure and provide the required toilets needed to satisfy the reservation requests for the event. At step 650, the event or facility operator sets up the toilets prior to the event and at step 660, which can be at any time prior to and up to the time of the event, the mobile restroom operator provides, by communication electronically with the reservation system of the embodiments, the mobile restroom configuration, identifiers, and locations for the event so that the reservation system of the embodiments can provide access codes to the users that reserved access to a toilet or group of toilets that are matched to their reservation parameters. Then, at step 665, which can be at any time prior to and up to the time of the event, access codes are provided to the user(s) that reserved toilets.

At step 670, a user accesses a reserved toilet in accordance with the teachings as disclosed above, uses the toilet at step 675 and exits the toilet enclosure. In some embodiments, the user can lock the enclosure manually, via the application on a mobile device or using a physical device containing the access code. The embodiments of the system and method can also automatically control the lock to secure entry into the enclosure after a set period of time and by detecting whether there is anyone in the enclosure, for example via a motion detector or camera such as disclosed in FIG. 1A. In a similar manner, the other connected devices of the embodiments can be controlled to either power down after a set period of time, or power up for a set period of time and then power down (e.g., the fan to clear the enclosure of unpleasant odors).

and is asked for and provides feedback at step 680. At step 685, which occurs continuously throughout the event, a level indicator, such as level sensor 145 of the embodiment described in FIG. 1A, measures levels in the toilet to determine when the toilet needs to be emptied and cleaned. At step 690, level indicator data and user feedback are provided over a network to the reservation system (e.g., server 185 in the embodiment of FIG. 1A) where it is processed and analyzed.

At step 695, the reservation system provides data and alerts to the mobile restroom operator, event operator, or facility operator, which can be data derived from the data received from the connected devices and user feedback. This data can comprise, for example, alerts to the operator that toilets need cleaning or other maintenance, feedback from users, or an indication that the toilets are no longer in use (e.g., because the event is over).

FIG. 6 is provided by way of example and not limitation. Various steps may be repeated, steps may be performed in different orders, steps omitted, and additional or alternative steps performed.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein. Rather, the description is intended to describe illustrative embodiments, features, and functions in order to provide a person of ordinary skill in the art context to understand the invention without limiting the invention to any particularly described embodiment, feature, or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a CPU, read-only memory (“ROM”), random access memory (“RAM”), hard drive (“HD”), input/output (“I/O”) device(s), and communication interfaces. The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer-readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. The processes described herein may be implemented in suitable computer-executable instructions that reside on a computer readable medium.

Any suitable programming language can be used to implement the routines, methods, or programs of embodiments of the invention described herein, including C, C++, Java, JavaScript, HTML, or any other programming or scripting code. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines, or portions thereof described herein, where such software programming or code can be stored in a computer-readable medium and can be operated on by a processor to permit a computer to perform any of the steps, operations, methods, routines, or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Such a computer-readable medium shall generally be machine readable and include software programming or code that can be human readable (e.g., source code) or machine readable (e.g., object code). Examples of non-transitory computer-readable media include random access memories, read-only memories, HDs, data cartridges, magnetic tapes, floppy diskettes, flash memory drives, optical data storage devices, CD-ROMs, and other appropriate computer memories and data storage devices. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals, or other information. A processor can include a system with a general-purpose CPU, multiple processing units, dedicated circuitry for achieving functionality, or other systems. Processing need not be limited to a geographic location or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, that follow, a term preceded by "a set", "a" or "an" (and "the" when antecedent basis is "a" or "an") includes both singular and plural of such term, unless clearly indicated otherwise (i.e., that the reference "a set", "a" or "an" clearly indicates only the singular or only the plural). Also, as used in the description herein the meaning of “in” includes “in” and “on” unless the context clearly dictates otherwise.

Although the foregoing specification describes specific embodiments, numerous changes in the details of the embodiments disclosed herein and additional embodiments will be apparent to, and may be made by, persons of ordinary skill in the art having reference to this disclosure. In this context, the specification and figures are to be regarded in an illustrative rather than a restrictive sense, and all such modifications are intended to be included within the scope of this disclosure.

What is claimed is:

1. A toilet reservation and access system comprising:
an enclosure defining an enclosable space containing a toilet, the enclosure having an entry to the enclosable space;
a lock having an open position and a locked position, the lock cyclable between the locked position and the open position for controlling use of the entry to access the enclosable space via the entry; and
a lock controller, the lock controller operable to cause said lock to cycle between the locked position and open position, wherein said controller is configured to cause said lock to cycle during a scheduled time based on receiving a user-provided access code that is a valid access code for the scheduled time.

2. The toilet reservation and access system of claim 1, wherein the lock controller comprises a memory storing a plurality of access codes.

3. The toilet reservation and access system of claim 2, wherein the lock controller is configured to:
receive, from a server, a schedule for a first access code from the plurality of access codes; and
determine that the user-provided access code is valid for the scheduled time based on the user-provided access code matching the first access code and a current time being a valid time according to the schedule.

4. The toilet reservation and access system of claim 2, wherein the memory stores a schedule for a first access code from the plurality of access codes, and wherein the lock controller is configured to:
determine that the user-provided access code is the valid access code for the scheduled time based on the user-provided access code matching the first access code and a current time being a valid time according to the schedule.

5. The toilet reservation and access system of claim 1, wherein the lock controller is configured to send the user-provided access code to a server for validation.

6. The toilet reservation and access system of claim 1, further comprising:
a code reader operatively connected to the lock controller, wherein the lock controller is configured to receive the user-provided access code from the code reader.

7. The toilet reservation and access system of claim 6, wherein the code reader is selected from a group consisting of: a QR code reader, an RFID reader, and an NFC reader.

8. The toilet reservation and access system of claim 1, wherein the lock comprises:
a locking mechanism; and
an actuator to actuate the locking mechanism, wherein the lock controller is configured to control the actuator to cycle the locking mechanism between the open position and the locked position.

9. The toilet reservation and access system of claim 1, further comprising a server, the server comprising:
a processor;
a non-transitory computer readable medium storing thereon computer-executable instructions, the computer-executable instructions comprising instructions for:
provide a catalog of available toilet options to a client device;
receiving from the client device a request to reserve the toilet for a requested date and time;
assigning an access code to a user to allow the user to access the toilet at the requested date and time;
sending the access code to the user; and
updating the catalog of available toilet options to remove the requested date and time for the toilet from the catalog of available toilet options.

10. A toilet reservation and access method comprising:
locking an entry to an enclosure defining an enclosable space containing a toilet with an electronically actuated lock that is cyclable between a locked position and an open position for controlling use of the entry to access the enclosable space via the entry;
wirelessly receiving a user-provided access code to access the toilet; and
actuating the electronically actuated lock to cycle the electronically actuated lock between the locked position and the open position during a scheduled time to allow access to the enclosable space based on a determination that the user-provided access code is a valid access code for the scheduled time.

11. The toilet reservation and access method of claim 10, storing a plurality of access codes in a controller memory of a lock controller that is communicatively coupled to the electronically actuated lock and associating a schedule with a first access code from the plurality of access codes.

12. The toilet reservation and access method of claim 11, further comprising configuring the lock controller with the schedule for the first access code via a wireless command.

13. The toilet reservation and access method of claim 11, further comprising the lock controller receiving the schedule from a server.

14. The toilet reservation and access method of claim 11, further comprising determining that the user-provided access code is valid for the scheduled time based on the user-provided access code matching the first access code and a current time being a valid time according to the schedule.

15. The toilet reservation and access method of claim 10, further comprising reading the user-provided access code using a code reader coupled to the enclosure and sending the user-provided access code to a server for validation.

16. The toilet reservation and access method of claim 15, wherein the code reader is selected from a group consisting of: a QR code reader, an RFID reader, and an NFC reader.

17. The toilet reservation and access method of claim 10, further comprising:
providing a catalog of available toilet options;
receiving a request to reserve the toilet for a requested date and time;
assigning a first access code to a user to allow the user to access the toilet at the requested date and time;
sending the first access code to the user; and
updating the catalog of available toilet options to remove the requested date and time for the toilet from the catalog of available toilet options.

18. A computer program product comprising a non-transitory, computer-readable medium storing a set of computer-executable instructions, the set of computer executable instructions comprising instructions for:
controlling an electronically actuated lock that is cyclable between an open position and a locked position to lock an entry to an enclosure housing a toilet;
wirelessly receiving a user-provided access code to access the toilet; and
actuating the electronically actuated lock to cycle the electronically actuated lock between the locked position and the open position during a scheduled time to allow access to the toilet based on a determination that the user-provided access code is a valid access code for the scheduled time.

19. The computer program product of claim 18, wherein the set of computer-executable instructions further comprises instructions for:
accessing a first access code and a schedule for the first access code from a memory; and
determining that the user-provided access code is the valid access code for the scheduled time based on the user-provided access code matching the first access code and a current time being a valid time according to the schedule.

20. The computer program product of claim 19, wherein the set of computer-executable instructions further comprises instructions for receiving the schedule for the first access code over a network from a server.

21. The computer program product of claim 19, wherein the set of computer-executable instructions further comprises instructions for sending the user-provided access code to a server for validation.
